(19) United States
(12) Patent Application Publication
(10) Pub. No.: US 2009/0302693 A1
(43) Pub. Date: Dec. 10, 2009

(54) Linear Motor

(76) Inventor: Houng Joong Kim, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/913,957

(22) PCT Filed: May 9, 2006
(86) PCT No.: PCT/JP2006/309316

§ 371 Date: Jul. 31, 2009

(30) Foreign Application Priority Data
May 10, 2005 (JP) 2005-136788

(51) Int. Cl. H02K 41/02; H02K 41/03

(52) U.S. Cl. 310/12.31; 310/12.18

(57) ABSTRACT

A linear motor includes a stator having an armature winding and a mover having permanent magnets, the stator and the mover arranged to be movable relatively, the stator forming a magnetic circuit including ring-form cores, armature teeth and the armature winding in order to prevent a large load from acting on a support mechanism of the mover to cause various troubles due to distortion of a structure when one-directional magnetic attraction acts between an armature and the mover. Slit grooves are disposed in the armature teeth opposite to both front and back sides of the permanent magnets of the mover through gap and protruding members capable of being moved along the slit grooves of the armature teeth are disposed on the surface of the permanent magnets, so that the magnetic attraction is canceled and the rigidity of members made of the permanent magnets is enhanced.

### TECHNICAL FIELD

The present invention relates to a linear motor, and more particularly a linear motor including a stator forming a magnetic circuit including ring-form cores, armature teeth and an armature winding, and a mover of permanent magnets being reciprocated in part of the ring-form cores through gap.

### BACKGROUND ART

Most of conventional linear motors have a structure in that a rotary machine is cut open to be developed straight, and each thereof includes a stator having an armature winding and a mover supported to the stator through gap relatively movably. Accordingly, large magnetic attraction acts between the stator and the mover, so that a large load acts on the support mechanism and the whole apparatus is made larger. An example of the conventional linear motor is described in JP-A-2003-250260.

### Patent Document 1: JP-A-2003-250260

### DISCLOSURE OF THE INVENTION

### Problem to be Solved by the Invention

However, in the prior art, a plurality of windings are wound on one stator unit and different windings are wound on adjacent magnetic poles of the stator, which makes the structure complex.

It is an object of the present invention to provide a linear motor in which magnetic attraction acting between a stator and a mover is canceled and the rigidity of members made of permanent magnet is enhanced in spite of a compact structure by devising an arrangement method of the armature winding in order to solve the above disadvantages.

### Means for Solving Problem

The linear motor according to the present invention includes a stator having an armature winding and a mover having permanent magnets, the stator and the mover being arranged to be movable relatively, and the stator of the linear motor forms a magnetic circuit including ring-form cores, armature teeth and the armature winding. Slit grooves are formed in the armature teeth opposite to both the front and back sides of the permanent magnets of the mover through gap, and protruding members capable of being moved along the slit grooves of the armature teeth are disposed on the surface of the permanent magnet.

### ADVANTAGES OF THE INVENTION

In the linear motor, the rigidity of the members made of permanent magnet can be enhanced.

Other objects, features and advantages of the present invention will be apparent from the following description of embodiments of the present invention taken in conjunction with the accompanying drawings.

### BEST MODE FOR CARRYING OUT THE INVENTION

Embodiments of the present invention are now described with reference to the accompanying drawings. In the drawings, like reference numerals designate like or equivalent elements.

The description is made to the embodiments, but the present invention is not limited thereto, and it is apparent for those skilled in the art that many changes and modifications may be made without departing from the spirit and scope of the present invention.

FIG. 1 is a basic schematic diagram illustrating a linear motor according to one embodiment of the present invention.

Referring now to FIG. 1, the linear motor includes a stator having an armature winding 4 and a mover 2 having permanent magnets, the stator and the mover being arranged to be movable relatively, and the stator of the linear motor forms a magnetic circuit including ring-form cores 1, armature teeth 3 and an armature winding 4. Slit grooves 10 are formed in the armature teeth 3 opposite to both the front and back sides of the permanent magnets of the mover through gap in part of the ring-form cores, and protruding members 11 capable of being moved along the slit grooves 10 of the armature teeth 3 are disposed on the surface of the permanent magnets.

Moreover, the armature teeth 3 are disposed in part of the ring-form cores in opposing relation to both the front and back sides of the permanent magnets of the mover 2 through gap, and guide rails 12 are disposed along the longitudinal direction of the mover. Support mechanisms 13 are disposed on the side of the ring-form cores 1 in a corresponding manner to the guide rails 12. In order to assemble a plurality of ring-form cores 1, through-holes 8 are formed in part of the ring-form cores.

Support mechanisms 13 are disposed on both ends of the mover 2. However, the support mechanisms and guide rails (not shown) of the mover may be combined mixedly. Further, a support method may be a non-contact support method using aerostatic pressure bearing, oil-static pressure bearing or the like, or a method of supporting the mover using plane sliding, linear guide rails or the like.

FIGS. 2A and 2B schematically illustrate the ring-form cores of the linear motor according to the embodiment of the present invention.

In FIGS. 2A and 2B, the armature winding 4 is wound on an odd-numbered ring-form core 1a and an even-numbered ring-form core 1b in common. In FIG. 2B, only two ring-form cores are shown. However, even if there are two or more ring-form cores, one armature winding 4 can be wound thereon in common.

FIG. 3 schematically illustrates a plurality of coils arranged in the linear motor according to one embodiment of the present invention.

In FIG. 3, armature windings 4 are disposed on the right and left sides of the ring-form cores by way of example. It is not necessary to wind the armature windings 4 in common to the whole of the ring-form cores, and the armature windings may be disposed anywhere as far as the mover 2 can be moved freely. Two armature windings are shown, though only one of them may be used.

FIGS. 8A and 8B schematically illustrate the concept of ring-form cores with gap and a mover of a linear motor of a magnetic attraction canceling type.

In FIGS. 8A and 8B, the armature teeth 3 opposite to both the front and back sides of the permanent magnets of the mover 2 through gap are disposed in part of the ring-form cores. Furthermore, FIGS. 9A and 9B also illustrate a linear motor of a magnetic attraction canceling type, which has a structure similar to that of the linear motor shown in FIGS. 8A and 8B.

FIGS. 4A and 4B illustrate one example of the structure of the movers having the enhanced rigidity in the linear motor shown in FIGS. 8A, 8B, 9A and 9B.

FIG. 4A illustrates the mover having protruding members 11 disposed in the middle thereof and FIG. 4B illustrates the mover 2 having members 12 disposed on both sides in the longitudinal direction of the mover 2.

Moreover, the mover 2 includes permanent magnets 7 arranged in an order of N, S, N and S poles at predetermined intervals.

The permanent magnets 7 of FIGS. 4A and 4B may be skewed, may have a predetermined space between N and S poles changed and may be formed into any shape except a square.

The linear motor may use ferromagnetic members instead of the permanent magnets forming the mover 2 shown in FIGS. 4A and 4B, and may use a structure having permanent magnets and ferromagnetic members combined. Further, the linear motor may use electromagnets using hollow coils instead of the permanent magnets, or may use electromagnets using coils wound on ferromagnetic members and arranged in an order of N, S, N and S poles.

FIGS. 5A and 5B illustrate a core and a mover of a linear motor according to another embodiment of the present invention.

FIG. 5A shows an example of a ring-form core of the linear motor including a plurality of slit grooves 10 (6 slit grooves consisting of 3 upper slit grooves and 3 lower slit grooves in FIGS. 5A, 5B) formed in the armature teeth 3 opposite to both the front and back sides of the permanent magnets of the mover 2 through gap in part of the ring-form core, and FIG. 5B shows an example of a plurality of protruding members 11 formed on both the front and back sides of the mover 2 in a corresponding manner to the grooves of the armature teeth.

FIGS. 6A and 6B illustrate a core and a mover of a linear motor according to another embodiment of the present invention.

As shown in FIGS. 6A and 6B, in a case where a plurality of protruding members are disposed on both the front and back sides of the mover 2, the protruding members are disposed in places shifted slightly from the center or along the longitudinal direction of the mover 2 on only one side thereof.

FIGS. 7A, 7B and 7C illustrate a core and a mover of a linear motor according to another embodiment of the present invention.

The mover 2 includes the protruding members 11 disposed along slit grooves 10 formed in the armature teeth 3 of a C-shaped ring-form core 1. An armature winding 4a is wound on the odd-numbered ring-form core 1a and an armature winding 4b is wound on the even-numbered ring-form core 1b as shown in FIG. 7B. Further, the protruding members 11 are disposed on the mover 2 as shown in FIG. 7C.

FIG. 10 illustrates a linear motor in a prior art.

In FIG. 10, the armature teeth 3 have no slit groove 10.

FIGS. 11A and 11B illustrate cores of a linear motor having slit grooves and no slit groove, respectively.

FIG. 11A shows a core shape having the slit grooves 10 formed in the armature teeth 3 of the linear motor of the present invention, and FIG. 11B shows a core shape having no slit groove 10 in the armature teeth 3 in the core shape of the linear motor in the prior art as shown in FIG. 10.

FIG. 12 is a schematic diagram illustrating a servo-controlled system using a linear motor of the present invention.

A linear motor 20 of the present invention is coupled to a moving body 21, and the system includes a driver 22, a controller 23, a displacement sensor 24 and the like, and drives the moving body by means of the linear motor in accordance with target instructions. In FIG. 12, a closed loop control system is formed using the displacement sensor 24, though an open loop control system having no displacement sensor may be formed according to uses. In addition, a current sensor and a magnetic pole sensor (not shown) may be used to form a high-accuracy and high-performance servo-controlled system.

In FIG. 12, the displacement sensor 24 includes an encoder scale (not shown) disposed along the longitudinal direction of the mover 2 and an encoder detector (not shown) disposed in a place opposite to the encoder scale to be used as a linear driving apparatus, similarly to the conventional linear motor.

In the linear motor of the present invention described above, an example of the armature winding disposed in the ring-form core or the armature teeth has been described, though these elements may be combined in a mixed manner with each other.

In the embodiment of the linear motor according to the present invention, not only the mover may be disposed on the side of the permanent magnets and the stator may be disposed on the side of the armature winding but also the mover may be disposed on the side of the armature winding and the stator may be disposed on the side of the permanent magnets.

Besides the embodiments having the combination described above, combination adopting only a part may be used. The constituent elements of the linear motor shown in the drawings may be combined over the drawings irrespective of the drawings, and the combination thereof may be molded.

### BRIEF DESCRIPTION OF THE DRAWINGS

FIG. 1

A diagram illustrating a basis of a linear motor according to one embodiment of the present invention.

FIG. 2A

A diagram illustrating ring-form cores of the linear motor according to one embodiment of the present invention.

FIG. 2B

A diagram illustrating ring-form cores of the linear motor according to one embodiment of the present invention.

FIG. 3

A diagram illustrating the arrangement of coils of the linear motor according to one embodiment of the present invention.

FIG. 4A

A diagram illustrating a mover of the linear motor according to one embodiment of the present invention.

FIG. 4B

A diagram illustrating a mover of the linear motor according to one embodiment of the present invention.

FIG. 5A

A diagram illustrating a core and a mover (part 1) of a linear motor according to another embodiment of the present invention.

FIG. 5B

A diagram illustrating the core and the mover (part 1) of the linear motor according to another embodiment of the present invention.

FIG. 6A

A diagram illustrating a core and a mover (part 2) of the linear motor according to another embodiment of the present invention.

FIG. 6B

A diagram illustrating the core and the mover (part 2) of the linear motor according to another embodiment of the present invention.

FIG. 7A

A diagram illustrating a core and a mover (part 3) of the linear motor according to another embodiment of the present invention.

FIG. 7B

A diagram illustrating the core and the mover (part 3) of the linear motor according to another embodiment of the present invention.

FIG. 7C

A diagram illustrating the core and the mover (part 3) of the linear motor according to another embodiment of the present invention.

FIG. 8A

A diagram illustrating ring-form cores having gap and a mover (part 1) of a linear motor.

FIG. 8B

A diagram illustrating ring-form cores having gap and a mover (part 1) of a linear motor.

FIG. 9A

A diagram illustrating ring-form cores having gap and a mover (part 2) of a linear motor.

FIG. 9B

A diagram illustrating ring-form cores having gap and a mover (part 2) of a linear motor.

FIG. 10

A diagram illustrating a linear motor in a prior art.

FIG. 11A

A diagram illustrating cores of a linear motor having slit grooves.

FIG. 11B

A diagram illustrating cores of a linear motor having no slit groove.

FIG. 12

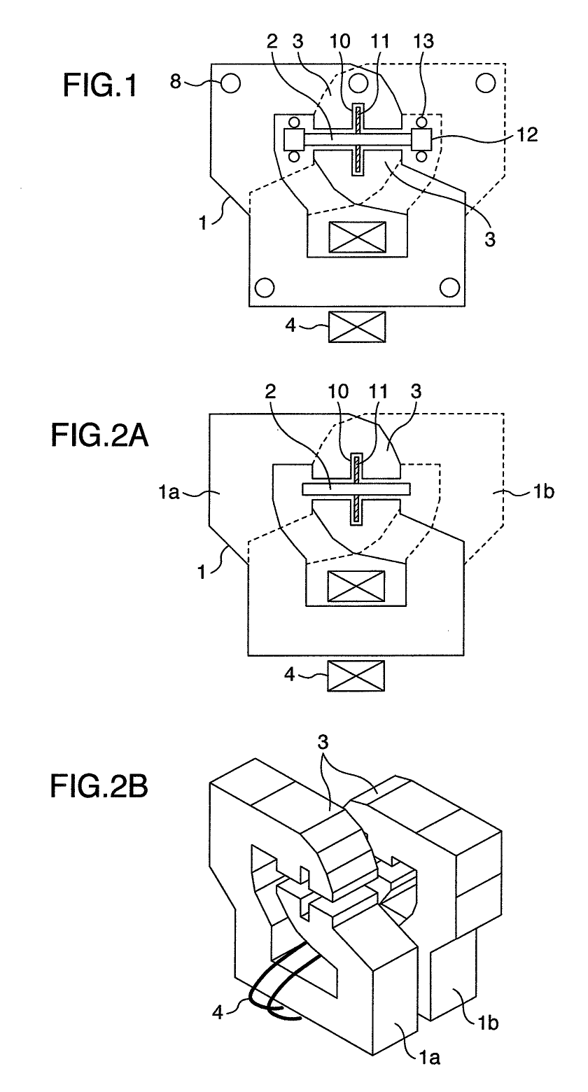

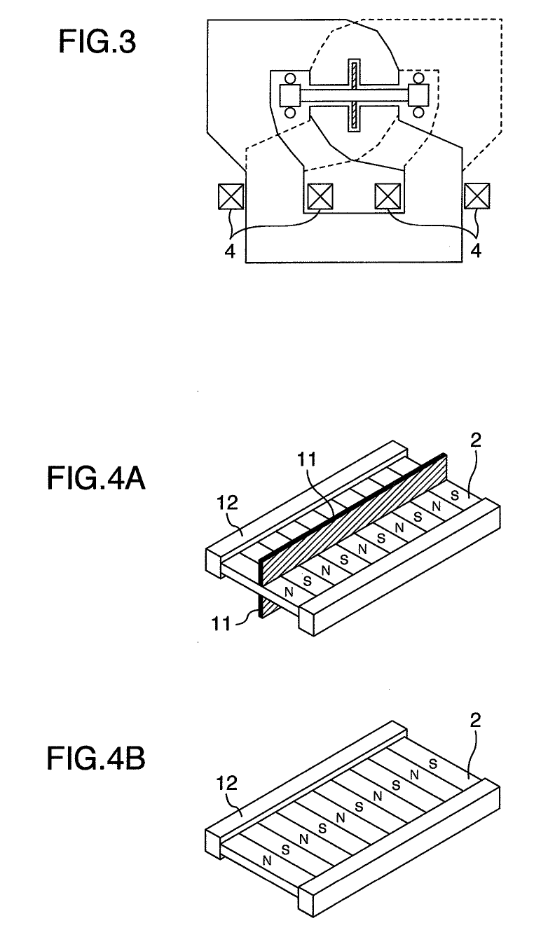

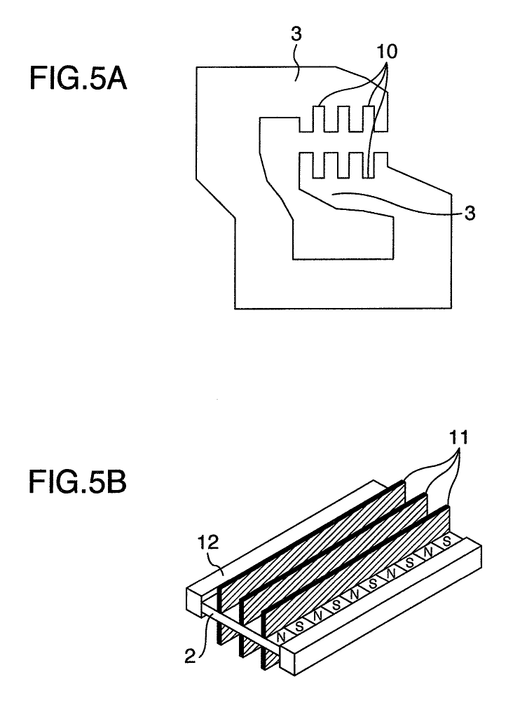

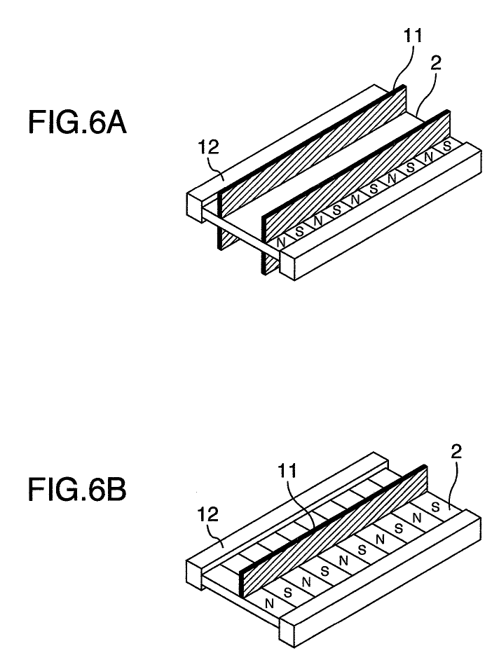

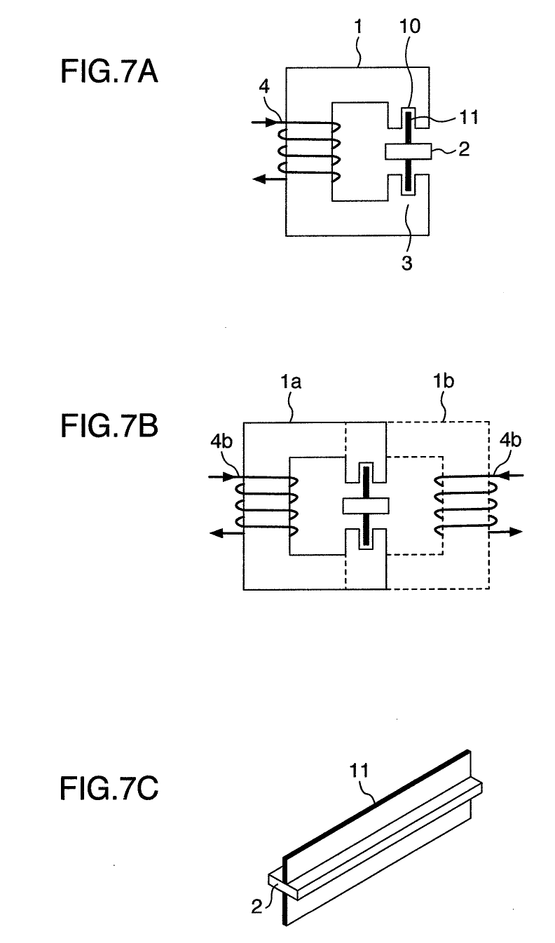

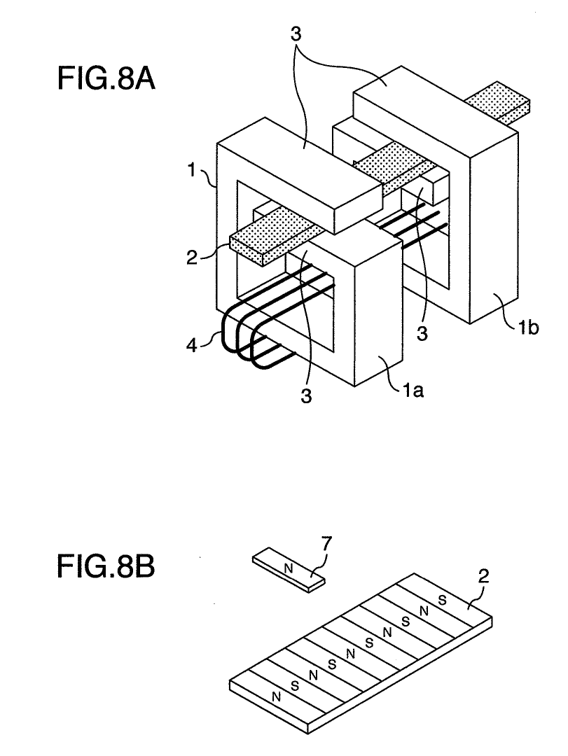

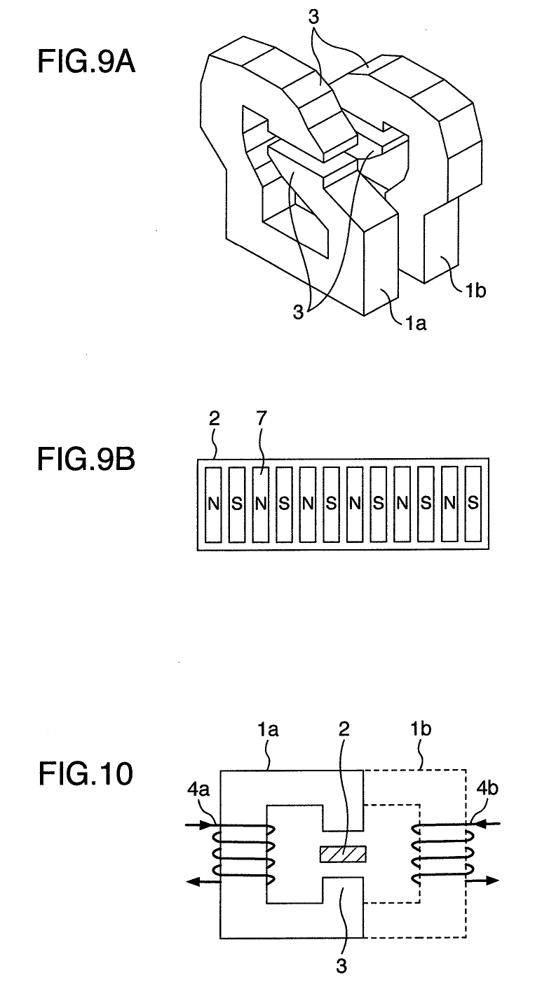

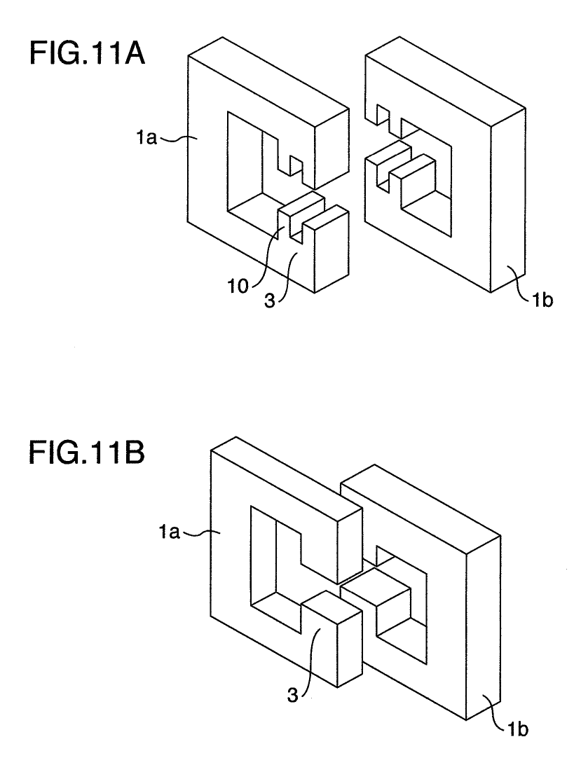

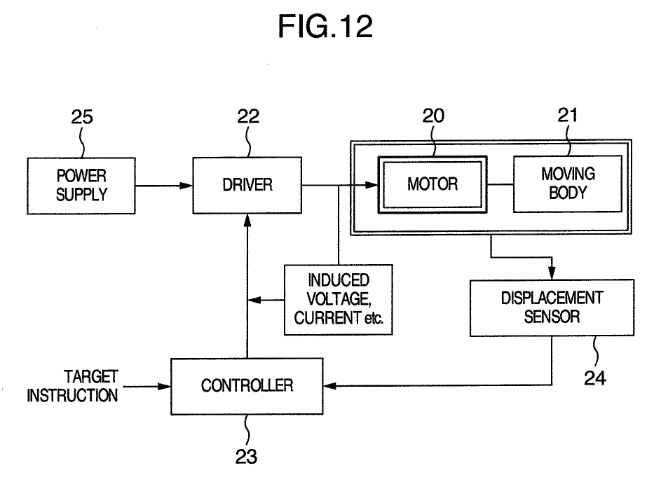

A schematic diagram illustrating a servo-controlled system using a linear motor of the present invention.

### DESCRIPTION OF REFERENCE NUMERALS

1 ring-form core
2 mover
3 armature teeth
4 armature winding
7 permanent magnet
8 through-hole
10 supporting slit groove
11 protruding member
12 guide rail
13 support mechanism (bearing)

1. A linear motor including armature teeth of a core having an armature winding and permanent magnets, the armature teeth being opposed to both front and back sides of the permanent magnets through gap to form a closed magnetic circuit, wherein slit grooves are formed in the armature teeth in a movement direction, and the permanent magnets are arranged along a traveling direction so that adjacent magnetic poles are different, protruding members being disposed to be able to be moved along the slit grooves of the armature teeth.

2. The linear motor according to claim 1, wherein a plurality of slit grooves are formed in the armature teeth opposite to both the front and back sides of the permanent magnets in the movement direction, the permanent magnets are arranged along the traveling direction so that adjacent magnetic poles are different, and a plurality of protruding members capable of being moved along the plurality of slit grooves of the armature teeth are disposed on surfaces of the permanent magnets.

3. The linear motor according to claim 1, wherein the permanent magnets are arranged along the movement direction so that the adjacent magnetic poles are different, and the protruding members are disposed on both the front and back sides of the permanent magnets arranged in the traveling direction.

4. A linear motor including a stator having an armature winding and a mover having permanent magnets, the stator and the mover arranged to be able to be moved relatively, wherein the stator forms a magnetic circuit including a ring-form core, armature teeth and the armature winding and the armature teeth opposite to both front and back sides of the permanent magnets of the mover through gap are disposed in part of the ring-form core, slit grooves being formed in the armature teeth in a movement direction, protruding members capable of being moved along the slit grooves of the armature teeth being disposed on surfaces of the permanent magnets.

5. The linear motor according to claim 1, comprising a guide mechanism for bearing disposed in a longitudinal direction in both ends or both sides of the mover being in contact with inner part of the ring-form core and a support mechanism provided in the stator in opposing relation to the guide mechanism.

6. The linear motor according to claim 1, wherein the stator is supported fixedly and the mover is moved.

7. The linear motor according to claim 1, wherein the mover is supported fixedly and the stator is moved.

8. The linear motor according to claim 1, wherein the protruding members disposed on the surfaces of the permanent magnets are made of material having relative permeability smaller than that of the core having the armature winding.

9. A linear motor including a primary side having an armature winding and a mover having field magnetic poles, the primary side and the mover being arranged to be movable relatively, wherein the primary side forms a magnetic circuit including a ring-form core, armature teeth and the armature winding, and the armature teeth opposite to both front and back sides of permanent magnets of the mover through gap are disposed in part of the ring-form core, slit grooves being formed in the armature teeth in a movement direction, protruding members capable of being moved along the slit grooves of the armature teeth being disposed on surfaces of the permanent magnets.

10. The linear motor according to claim 9, wherein the permanent magnets are arranged in a traveling direction so that adjacent magnetic poles are different, and the protruding members are disposed on both the front and back sides of the permanent magnets arranged in the traveling direction.
